(19) United States
(12) Patent Application Publication
(10) Pub. No.: US 2021/0352372 A1
(43) Pub. Date: Nov. 11, 2021

(54) INTERACTIVE COMMENTING IN AN ON-DEMAND VIDEO

(71) Applicant: ARRIS Enterprises LLC, Suwanee, GA (US)

(72) Inventors: Luyan Sun, Shanghai (CN); Qi Wang, Shanghai (CN); Wan-Ting Yang, Shanghai (CN); Hong-Bin Zhao, Shanghai (CN)

(73) Assignee: ARRIS Enterprises LLC, Suwanee, GA (US)

(21) Appl. No.: 17/241,748

(22) Filed: Apr. 27, 2021

Related U.S. Application Data
(63) Continuation of application No. PCT/CN2020/088674, filed on May 6, 2020.

(51) Int. Cl. H04N 21/4788; H04N 21/488; H04N 21/472; H04N 21/431

(52) U.S. Cl. CPC H04N 21/4788; H04N 21/4888; H04N 21/4312; H04N 21/47202; H04N 21/4882

(57) ABSTRACT

A method, system, and computer program product for interactive commenting in an on-demand video includes a processor to receive an on-demand video file selection from a first user for display on a first user device. The processor can receive a first input from the first user via a first graphical user interface at a first time of the video file and determine a time interval of the selected video file associated with the first input. The processor can identify one or more second users on one or more second user devices within the time interval of the video file and display the first input from the first user to the one or more second users within the time interval of the video file on the one or more second user devices via one or more second graphical user interfaces over the video file.

### FIELD OF THE INVENTION

The present invention relates generally to a method, system, and computer program product for interactive commenting in an on-demand video, and more particularly to enabling interactions between concurrent viewers of an on-demand video file via a bullet screen interface.

### BACKGROUND OF THE INVENTION

User commenting in on-demand videos has become increasing popular in recent years, especially in Asia-Pacific countries. One particularly popular application for user commenting in on-demand videos is known as a bullet screen. Originating in Japan, the bullet screen or “danmaku” in Japanese enables viewers of uploaded videos to enter comments which are then displayed directly on top of the uploaded videos. Thus, the individual viewers are able to interact with one another while watching the same uploaded video. In a bullet screen interface, viewers enter comments via an input box and the input is then sent to the server hosting the video which then displays the comments as a scrolling comment across the screen on top of the video. The comments scroll across the screen fairly quickly; thus, resembling a “bullet” shooting across the screen and hence the name “bullet screen.” In current bullet screen interfaces, the user comments from all viewers of a video are collected by a server and displayed via the bullet screen interface regardless of when a viewer is actually watching and commenting on the video; therefore, is not possible for viewers to know when a particular comment on a video was posted, i.e. if it is a recent comment or an old comment. Thus, there is a need for a technical solution for interactive commenting between real-time viewers of an on-demand video.

### SUMMARY OF THE INVENTION

The present disclosure provides a description of exemplary methods, systems, and computer program products for interactive commenting in an on-demand video. The methods, systems, and computer program products may include a processor which can receive a video file selection from a first user for display on a first user device, wherein the video file is an on-demand video file. The processor may receive a first input from the first user on the first user device via a first graphical user interface at a first time of the video file and determine a time interval of the selected video file based on the first time of the video file associated with the first input from the first user. The processor may identify one or more second users on one or more second user devices within the time interval of the video file and display the first input from the first user to the one or more second users within the time interval of the video file on the one or more second user devices via one or more second graphical user interfaces over the video file. The processor may receive a second input from one of the one or more second users via one of the one or more second graphical user interfaces at a second time of the video file. The second input may be a reply to the first input. In response to determining the second input is not within the time interval, the processor may display the second input to the first user via the first graphical user interface in a first color over the video file. In response to determining the second input is within the time interval, the processor may display the second input to the first user via the first graphical user interface in a second color over the video file.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1a is a block diagram that illustrating a high-level system architecture for interactive commenting in an on-demand video in accordance with exemplary embodiments;

FIG. 1b illustrates example operating modules of the interactive bullet screen program of FIG. 1a in accordance with exemplary embodiments;

FIG. 1c illustrates an example graphical user interface in accordance with exemplary embodiments;

FIG. 2a is a flow chart illustrating exemplary methods for interactive commenting in an on-demand video in accordance with exemplary embodiments;

FIG. 2b is a flow chart illustrating exemplary methods for interactive commenting in an on-demand video in accordance with exemplary embodiments; and

FIG. 3 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure

### DETAILED DESCRIPTION OF THE PREFERRED EMBODIMENTS AND METHODS

The present disclosure provides a novel solution for interactive commenting in an on-demand video. In current bullet screen interfaces, user comments from all viewers of a video are collected by a server and displayed on top of the video via the bullet screen interface regardless of when a viewer is actually watching and commenting on the video. Thus, in current technology, is not possible for viewers to know when a particular bullet screen comment on a video was posted, i.e. if it is a recent comment or an old comment. Further, in current technology, it is not possible for viewers to know if the user who made a bullet screen comment is currently watching the video, if the user who made the comment is at the same time interval of the video as the viewer, or if the bullet screen comment is from a past viewer. Thus, in current on-demand video commenting, where the comments are displayed on top of the video, there is no way for a viewer to know if the comments are from other real-time viewers, e.g. other viewers currently and actively watching the same video. The methods, systems, and computer program products herein provide a novel solution, not addressed by current technology, by enabling concurrent viewers of an on-demand video to interact. Exemplary embodiments of the methods, systems, and computer program products provided for herein determine a time interval of a video associated with a particular comment and then identify any user currently watching the video at that time interval, e.g. minute ten to minute eleven of the video. Further, exemplary embodiments of the methods, systems, and computer program products provided for herein then display the comment to the other users currently watching the video at that time interval in a different style than other comments associated with the video. Thus, the methods, systems, and computer program products provided for herein provide a novel way for a viewer of an on-demand video to interact directly with other viewers who are at the same time-interval of the on-demand video.

### System for Interactive Commenting in an On-Demand Video

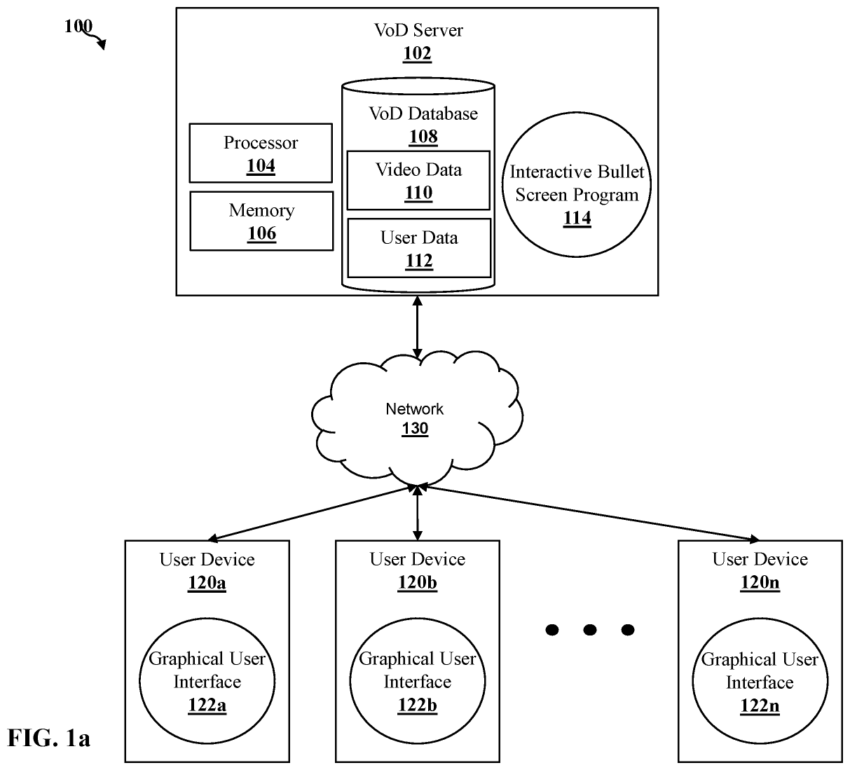

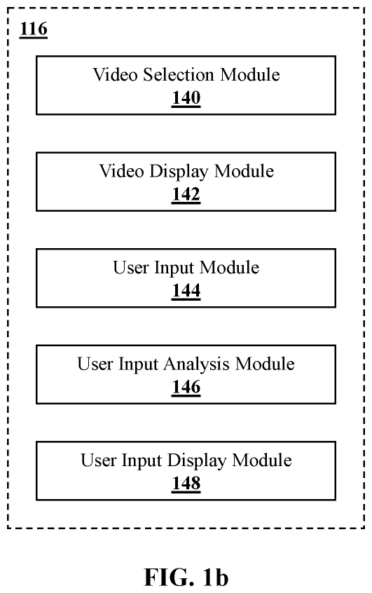

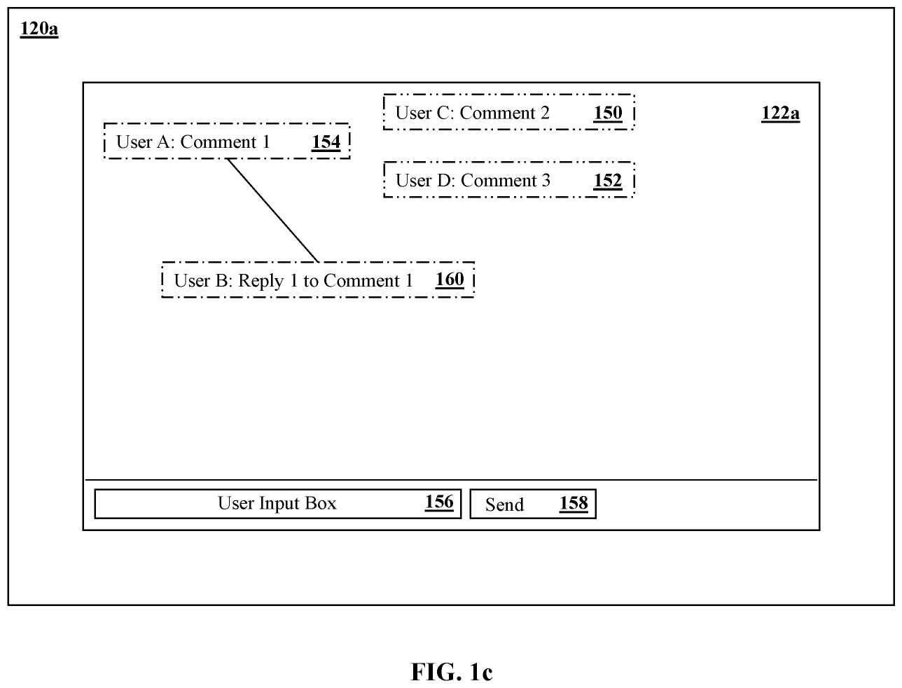

FIG. 1a illustrates an exemplary system 100 for interactive commenting in an on-demand video. The system 100 includes a Video-on-Demand (VoD) Server 102 and user devices 120a-n communicating via a network 130.

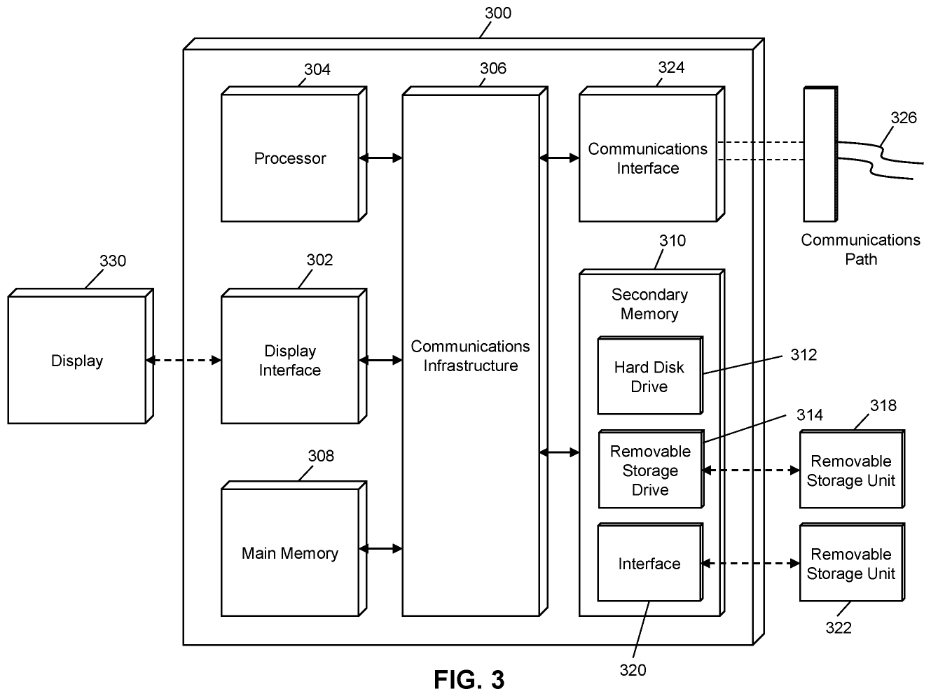

The VoD server 102 includes, for example, a processor 104, a memory 106, a VoD database 108, and an interactive bullet screen program 114. The VoD server 102 may be any type of electronic device or computing system specially configured to perform the functions discussed herein, such as the computing system 300 illustrated in FIG. 3. Further, it can be appreciated that the VoD server 102 may include one or more computing devices. In an exemplary embodiment of the system 100, the VoD server 102 is a server associated with any media services provider providing a Video-on-Demand (VoD) service.

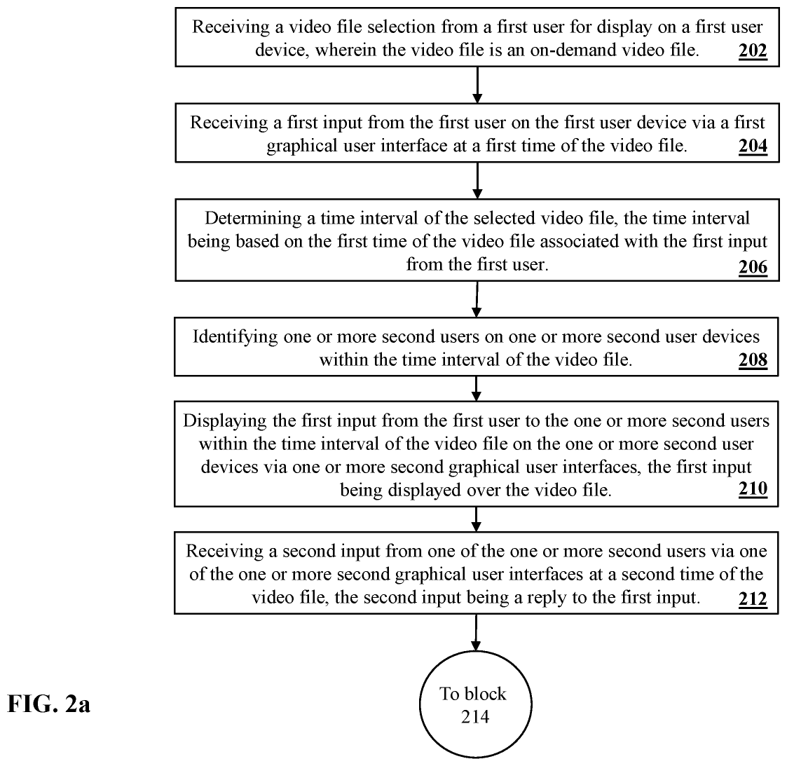

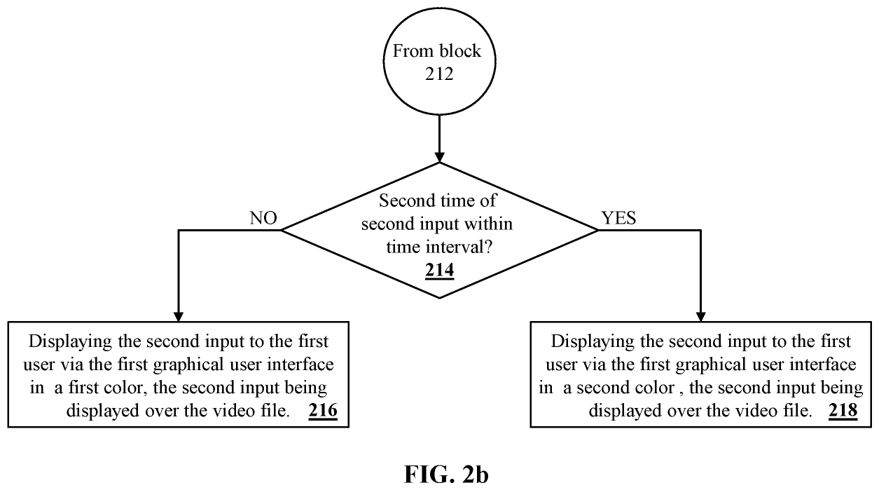

The processor 104 may be a special purpose or a general purpose processor device specifically configured to perform the functions discussed herein. The processor 104 unit or device as discussed herein may be a single processor, a plurality of processors, or combinations thereof. Processor devices may have one or more processor “cores.” In an exemplary embodiment, the processor 104 is configured to perform the functions associated with the modules of the interactive bullet screen program 114 as discussed below with reference to FIGS. 1b-2.

The memory 106 can be a random access memory, read-only memory, or any other known memory configurations. Further, the memory 106 can include one or more additional memories including the VoD database 108 in some embodiments. The memory and the one or more additional memories can be read from and/or written to in a well-known manner. In an embodiment, the memory and the one or more additional memories can be non-transitory computer readable recording media. Memory semiconductors (e.g., DRAMs, etc.) can be means for providing software to the computing device such as the interactive bullet screen program 114. Computer programs, e.g., computer control logic, can be stored in the memory 106.

The VoD database 108 can include video data 110 and user data 112. The VoD database 108 can be any suitable database configuration, such as a relational database, a structured query language (SQL) database, a distributed database, or an object database, etc. Suitable configurations and storage types will be apparent to persons having skill in the relevant. In an exemplary embodiment of the system 100, the VoD data base 108 stores video data 110 and user data 112. The video data 110 can be any video file such as, but not limited to, movies, television episodes, music videos, or any other on-demand videos. Further, the video data 110 may be any suitable video file format such as, but not limited to, .WEBM, .MPG, .MP2, .MPEG, .MPE, .MPV, .OGG, .MP4, .M4P, .M4V, .AVI, .WMV, .MOV, .QT, .FLV, .SWF, and AVCHD, etc. In an exemplary embodiment, the video data 110 may be selected by a user on one or more of the user devices 120a-n and displayed on a display of the user devices 120a-n. The user data 112 may be any data associated with the user devices 120a-n including, but not limited to, user account information (e.g. user login name, password, preferences, etc.), input data received from one or more of the user devices 120a-n to be displayed in association with a video file via the graphical user interfaces 122a-n (e.g. user comments to be displayed), etc. In an exemplary embodiment, the user data 112 can be user comments associated with one or more of the video files of the video data 110. For example, the user data 112 may be user comments associated with a particular episode of a television show stored in the VoD database 108 as part of the video data 110.

The interactive bullet screen program 114 can include the video selection module 140, the video display module 142, the user input module 144, the user input analysis module 146, and the user input display module 148 as illustrated in FIG. 1b. The interactive bullet screen program 114 is a computer program specifically programmed to implement the methods and functions disclosed herein for interactive commenting in a bullet screen. The interactive bullet screen program 114 and the modules 140-148 are discussed in more detail below with reference to FIGS. 1b-2.

The user devices 120a-n can include graphical user interfaces 122a-n. The user devices 120a-n may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the VoD database 102 via the network 130. Further, it can be appreciated that the user devices 120a-n may include one or more computing devices.

The graphical user interfaces 122a-n can include components used to receive input from the user devices 120a-n and transmit the input to the interactive bullet screen program 114, or conversely to receive information from the interactive bullet screen program 114 and display the information on the user devices 120a-n. In an example embodiment, the graphical user interfaces 122a-n uses a combination of technologies and devices, such as device drivers, to provide a platform to enable users of user devices 120a-n to interact with the interactive bullet screen program 114. In the example embodiment, the graphical user interfaces 122a-n receives input from a physical input device, such as a keyboard, mouse, touchpad, touchscreen, camera, microphone, etc. For example, the graphical user interfaces 122a-n may receive comments from one or more of the user devices 120a-n and display those comments to the user devices 120a-n. In an exemplary embodiment, the graphical user interfaces 122a-n are bullet screen interfaces that are displayed over the video data 110. Further, in exemplary embodiments, the graphical user interfaces 122a-n are bullet screen interfaces that receive user input, such as textual comments, from one or more of the user devices 120a-n and display the input to the user devices 120a-n as a scrolling object across a display of the user devices 120a-n. FIG. 1c illustrates an example graphical user interface 122a in accordance with exemplary embodiments and will be discussed in further detail below.

The network 130 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. In general, the network 130 can be any combinations of connections and protocols that will support communications between the VoD server 102, and the user devices 120a-n. In some embodiments, the network 130 may be optional based on the configuration of the VoD server 102 and the user devices 120a-n.

### Exemplary Method for Interactive Commenting in a Bullet Screen

FIG. 2 illustrates a flow chart of an exemplary method 200 for interactive commenting in a bullet screen in accordance with exemplary embodiments.

In an exemplary embodiment, the method 200 can include block 202 for receiving a video file selection from the video data 110 stored on the VoD database 108 by a first user for display on a first user device, e.g. the user device 120a. The video file may be an on-demand video file selected from the video data 110 stored on the VoD database 108 via the graphical user interface 122a by the user on the user device 120a. For example, a first user on the user device 120a may select an episode of a television show stored on the VoD database 108 to view on the user device 120a. The video files stored as the video data 110 on the VoD database 108 can include past user comments, e.g. from one or more second users, associated with one or more time intervals of the video files. The past user comments associated with the video files of the video data 110 can include, for example, user comments from one or more second users who previously watched the video file or from one or more second users who are currently watching the video file but are ahead of the first user by a defined period of time. In an exemplary embodiment, the past user comments associated with the video files of the video data 110 may be displayed on the video files in a first defined style such as, but not limited to, a first color, a first font, a first font size, a first highlighted text, a first underlined text, a first bolded text, etc. For example, referring to FIG. 1c, a video file may have past user comments 150-152, e.g. comments 2-3 from users C-D, which may be displayed on the user interface 122a in a first color. The one or more time intervals of the video files may be ay segment of the video files such as, but not limited to, seconds, minutes, chapters of the video, etc. Further, in an exemplary embodiment, the graphical user interfaces 122a-n are bullet screen interfaces and the past user comments are displayed on the user devices 120a-n as “bullet” comments where the past user comments scroll across the graphical user interface over the video file. In an exemplary embodiment of the system 100, the video selection module 140 and the video display module 142 can be configured to execute the method of block 202.

In an exemplary embodiment, the method 200 can include block 204 for receiving a first input from the first user on the first user device, e.g. the user device 120a, via a first graphical user interface, e.g. the graphical user interface 122a, at a first time of the selected video file. The first user may enter the first input into the user device 120a via the graphical user interface 122a. In an exemplary embodiment, the first input is received from the user device 120a at the VoD server 102 via the network 130. For example, referring to FIG. 1c, the first user, e.g. user A, may input the comment 154, e.g. comment 1, via the user input box 156 on the first graphical user interface, e.g. the graphical user interface 122a. The first input can be any user input, such as, but not limited to, a textual input, an image file input, an audio input, or any other suitable user input. The first input may be entered via the graphical user interface 122a using any suitable input device including, but not limited to, a keyboard, a touchpad, a microphone, a camera, a mouse, etc. Further, the first input may be sent to the VoD server 102 using a button, such as the send button 160, on the graphical user interface 122a. In an exemplary embodiment of the system 100, the user input module 144 can be configured to execute the method of block 204.

In an exemplary embodiment, the method 200 can include block 206 for determining a time interval of the selected video file. The time interval of the video file is based on the first time of the video associated with the first input from the first user on the first user device, e.g. the first user device 120a. The time interval can be, for example, pre-defined by the interactive bullet screen program 114, manually defined by a user of the interactive bullet screen program 114, or automatically determined by the interactive bullet screen program 114, etc. The time interval may be, for example, a one-minute time period measured from the first time of the received first input, or each one-minute time interval of the video file. For example, the first user on the user device 120a may be watching an episode of a television show, e.g. the selected video file, which has a one-hour runtime and the one or more time intervals of the video file may be every one-minute segment of the video file. Continuing with the previous example, the first user may enter the first input at the twelve minute, forty-five second point of the video file and the determined time interval can be the one-minute period from the twelfth minute to the thirteenth minute of the video file or it could the one-minute period starting from the twelve minute, forty-five second point, e.g. from twelve minutes, forty-five seconds to thirteen minutes, forty-five seconds. In an exemplary embodiment of the system 100, the user analysis module 146 can be configured to execute the method of block 206.

In an exemplary embodiment, the method 200 can include block 208 for identifying one or more second users on one or more second user devices, e.g. the user devices 120b-n, within the determined time interval of the video file. The system 100 can identify the one or more second users by identifying one or more user devices 120a-n connected to the VoD server 102 via the network 130. Further, the one or more second users may be connected to the VoD server 102 via the interactive bullet screen program 114. Following the example above, the system 100 may identify one or more second users viewing the selected video file between the twelfth minute to the thirteenth minute of the video file or from twelve minutes, forty-five seconds to thirteen minutes, forty-five seconds. In an exemplary embodiment of the system 100, the user analysis module 146 can be configured to execute the method of block 208.

In an exemplary embodiment, the method 200 can include block 210 for displaying the first input from the first user to the one or more second users within the determined time interval of the video file on the one or more second user devices, e.g. the user devices 120b-n, via one or more second graphical user interfaces, e.g. the graphical user interfaces 122b-n. In an exemplary embodiment, the first input may be displayed to the one or more second users in a second defined style such as, but not limited to, a second color, a second font, a second font size, a second highlighted text, a second underlined text, a second bolded text etc. For example, referring to FIG. 1c, the system 100 can display a first user input 154, e.g. comment 1, from the first user, e.g. user A, on the graphical user interfaces 122b-n on the user devices 120b-n of the one or more second users in a second color. Therefore, the one or more second users will see the first input from the first user in a different color compared to the past user comments associated with the selected video file. Thus, the one or more second users will know that the first input is from another user actively viewing the video file within the same time interval as the one or more second users. In an exemplary embodiment of the system 100, the user input display module 148 can be configured to execute the method of block 210.

In an exemplary embodiment, the method 200 can include block 212 for receiving a second input from one of the one or more second users via one of the one or more second graphical user interfaces, e.g. the graphical user interfaces 122b-n, at a second time of the video. In an exemplary embodiment, the second input is a reply to the first input from the first user. For example, the second user may enter the second input into the user device 120b via the graphical user interface 122b. In an exemplary embodiment, the second input is received from the user device 120b at the VoD server 102 via the network 130. For example, referring to FIG. 1c, the second user, e.g. user B, may input the comment 160, e.g. reply 1 to comment 1, via the user input box 156 on a second graphical user interface, e.g. the graphical user interface 122b. The second input can be any user input, such as, but not limited to, a textual input, an image file input, an audio input, or any other suitable user input. The second input may be entered via the graphical user interface 122b using any suitable input device including, but not limited to, a keyboard, a touchpad, a microphone, a camera, a mouse, etc. Further, the second input may be sent to the VoD server 102 using a button, such as the send button 160, on the graphical user interface 122b. In exemplary embodiments, the second user may select the first input to enter the second input by using a physical input device, such as a mouse, to click on and select the first input. In other exemplary embodiments, the second user may enter the second input into the graphical user interface 122b and the system 100 may identify the second input as a reply to the first input using natural language processing (NLP). For example, the system 100 may analyze the second input for keywords, user names, topics, etc. in order to identify the second input as a reply to the first input. In an exemplary embodiment of the system 100, the user input module 144 can be configured to execute the method of block 212.

In an exemplary embodiment, the method 200 can include block 214 for determining whether the second time of the second input is within the time interval of the video file associated with the first input from the first user. In an exemplary embodiment of the system 100, the user analysis module 146 can be configured to execute the method of block 214. In response to determining that the second input is not within the time interval of the video file associated with the first input from the first user, the system 100 may proceed to block 216. In response to determining that the second input is within the time interval of the video file associated with the first input from the first user, the system 100 may proceed to block 218.

In an exemplary embodiment, the method 200 can include block 216 for displaying the second input to the first user on the first user device, e.g. the user device 120a, via the first graphical user interface, e.g. the graphical user interface 122a, in a first color. In an exemplary embodiment, the second input may be displayed to the first user in the first defined style. Therefore, the first user and the remaining second users will see the second input from the second user in the same color as the past user comments associated with the selected video file. Thus, the first user and the remaining second users will know that the second input is from another user who previously watched the video file or from another user watching the video file outside the same time interval as the first user and the remaining second users. In an exemplary embodiment of the system 100, the user input display module 148 can be configured to execute the method of block 216.

In an exemplary embodiment, the method 200 can include block 218 for displaying the second input to the first user on the first user device, e.g. the user device 120a, via the first graphical user interface, e.g. the graphical user interface 122a, in a second color. In an exemplary embodiment, the second input may be displayed to the first user in the second defined style. Therefore, first user and the remaining one or more second users will see the second input from the second user in a different color or other visually distinguishable characteristic from the past user comments associated with the selected video file. Thus, the first user and the remaining one or more second users will know that the second input is from another user actively viewing the video file within the same time interval as the first user and the remaining one or more second users. In an exemplary embodiment of the system 100, the user input display module 148 can be configured to execute the method of block 218.

### Computer System Architecture

FIG. 3 illustrates a computer system 300 in which embodiments of the present disclosure, or portions thereof, may be implemented as computer-readable code. For example, the VoD server 102 and the user devices 120a-n of FIG. 1a may be implemented in the computer system 300 using hardware, software executed on hardware, firmware, non-transitory computer readable media having instructions stored thereon, or a combination thereof and may be implemented in one or more computer systems or other processing systems. Hardware, software, or any combination thereof may embody modules, such as the modules 140-148 of FIG. 1b, and components used to implement the methods of FIGS. 2a-2b.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 318, a removable storage unit 322, and a hard disk installed in hard disk drive 312.

Various embodiments of the present disclosure are described in terms of this example computer system 300. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 304 may be a special purpose or a general purpose processor device specifically configured to perform the functions discussed herein. The processor device 304 may be connected to a communications infrastructure 306, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 300 may also include a main memory 308 (e.g., random access memory, read-only memory, etc.), and may also include a secondary memory 310. The secondary memory 310 may include the hard disk drive 312 and a removable storage drive 314, such as a floppy disk drive, a magnetic tape drive, an optical disk drive, a flash memory, etc.

The removable storage drive 314 may read from and/or write to the removable storage unit 318 in a well-known manner. The removable storage unit 318 may include a removable storage media that may be read by and written to by the removable storage drive 314. For example, if the removable storage drive 314 is a floppy disk drive or universal serial bus port, the removable storage unit 318 may be a floppy disk or portable flash drive, respectively. In one embodiment, the removable storage unit 318 may be non-transitory computer readable recording media.

In some embodiments, the secondary memory 310 may include alternative means for allowing computer programs or other instructions to be loaded into the computer system 300, for example, the removable storage unit 322 and an interface 320. Examples of such means may include a program cartridge and cartridge interface (e.g., as found in video game systems), a removable memory chip (e.g., EEPROM, PROM, etc.) and associated socket, and other removable storage units 322 and interfaces 320 as will be apparent to persons having skill in the relevant art.

Data stored in the computer system 300 (e.g., in the main memory 308 and/or the secondary memory 310) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 300 may also include a communications interface 324. The communications interface 324 may be configured to allow software and data to be transferred between the computer system 300 and external devices. Exemplary communications interfaces 324 may include a modem, a network interface (e.g., an Ethernet card), a communications port, a PCMCIA slot and card, etc. Software and data transferred via the communications interface 324 may be in the form of signals, which may be electronic, electromagnetic, optical, or other signals as will be apparent to persons having skill in the relevant art. The signals may travel via a communications path 326, which may be configured to carry the signals and may be implemented using wire, cable, fiber optics, a phone line, a cellular phone link, a radio frequency link, etc.

The computer system 300 may further include a display interface 302. The display interface 302 may be configured to allow data to be transferred between the computer system 300 and external display 330. Exemplary display interfaces 302 may include high-definition multimedia interface (HDMI), digital visual interface (DVI), video graphics array (VGA), etc. The display 330 may be any suitable type of display for displaying data transmitted via the display interface 302 of the computer system 300, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 308 and secondary memory 310, which may be memory semiconductors (e.g., DRAMs, etc.). These computer program products may be means for providing software to the computer system 300. Computer programs (e.g., computer control logic) may be stored in the main memory 308 and/or the secondary memory 310. Computer programs may also be received via the communications interface 324. Such computer programs, when executed, may enable computer system 300 to implement the present methods as discussed herein. In particular, the computer programs, when executed, may enable processor device 304 to implement the methods illustrated by FIGS. 2a-2b, as discussed herein. Accordingly, such computer programs may represent controllers of the computer system 300. Where the present disclosure is implemented using software, the software may be stored in a computer program product and loaded into the computer system 300 using the removable storage drive 314, interface 320, and hard disk drive 312, or communications interface 324.

The processor device 304 may comprise one or more modules or engines, such as the modules 140-148, configured to perform the functions of the computer system 300. Each of the modules or engines may be implemented using hardware and, in some instances, may also utilize software, such as corresponding to program code and/or programs stored in the main memory 308 or secondary memory 310. In such instances, program code may be compiled by the processor device 304 (e.g., by a compiling module or engine) prior to execution by the hardware of the computer system 300. For example, the program code may be source code written in a programming language that is translated into a lower level language, such as assembly language or machine code, for execution by the processor device 304 and/or any additional hardware components of the computer system 300. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 300 to perform the functions disclosed herein. It will be apparent to persons having skill in the relevant art that such processes result in the computer system 300 being a specially configured computer system 300 uniquely programmed to perform the functions discussed above.

Techniques consistent with the present disclosure provide, among other features, systems and methods for authentication of a client device using a hash chain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope

What is claimed is:

1. A method for interactive commenting in an on-demand video, the method comprising:
receiving a video file selection from a first user for display on a first user device, wherein the video file is an on-demand video file;
receiving a first input from the first user on the first user device via a first graphical user interface at a first time of the video file;
determining a time interval of the selected video file, the time interval being based on the first time of the video file associated with the first input from the first user;
identifying one or more second users on one or more second user devices within the time interval of the video file; and
displaying the first input from the first user to the one or more second users within the time interval of the video file on the one or more second user devices via one or more second graphical user interfaces, the first input being displayed over the video file.

2. A method according to claim 1, comprising:
receiving a second input from one of the one or more second users via one of the one or more second graphical user interfaces at a second time of the video file, the second input being a reply to the first input;
in response to determining the second input is not within the time interval, displaying the second input to the first user via the first graphical user interface in a first color, the second input being displayed over the video file; and
in response to determining the second input is within the time interval, displaying the second input to the first user via the first graphical user interface in a second color, the second input being displayed over the video file.

3. A method as in claim 1, wherein the video file has one or more past user comments associated with one or more time intervals of the video

4. A method as in claim 3, wherein the one or more past user comments are displayed in a first color

5. A method as in claim 4, wherein the first user input is displayed in a second color

6. A method as in claim 1, wherein the first graphical user interface and the one or more second graphical user interfaces are bullet screen interfaces.

7. A system for interactive commenting in an on-demand video, the system comprising:
one or more processors, one or more computer-readable memories, one or more computer-readable tangible storage devices, and instructions stored on at least one of the one or more storage devices for execution by at least one of the one or more processors via at least one of the one or more memories, the instructions comprising:
instructions to receive a video file selection from a first user for display on a first user device, wherein the video file is an on-demand video file;
instructions to receive a first input from the first user on the first user device via a first graphical user interface at a first time of the video file;
instructions to determine a time interval of the selected video file, the time interval being based on the first time of the video file associated with the first input from the first user;
instructions to identify one or more second users on one or more second user devices within the time interval of the video file; and
instructions to display the first input from the first user to the one or more second users within the time interval of the video file on the one or more second user devices via one or more second graphical user interfaces, the first input being displayed over the video file.

8. A system according to claim 7, comprising:
instructions to receive a second input from one of the one or more second users via one of the one or more second graphical user interfaces at a second time of the video file, the second input being a reply to the first input;
in response to determining the second input is not within the time interval, instructions to display the second input to the first user via the first graphical user interface in a first color, the second input being displayed over the video file; and
in response to determining the second input is within the time interval, instructions to display the second input to the first user via the first graphical user interface in a second color, the second input being displayed over the video file.

9. A system as in claim 1, wherein the video file has one or more past user comments associated with one or more time intervals of the video

10. A system as in claim 9, wherein the one or more past user comments are displayed in a first color

11. A system as in claim 10, wherein the first user input is displayed in a second color

12. A system as in claim 7, wherein the first graphical user interface and the one or more second graphical user interfaces are bullet screen interfaces.

13. A computer program product for interactive commenting in an on-demand video, the computer program product comprising:
a computer-readable storage medium having program instructions embodied therewith, the program instructions executable by a computer to cause the computer to perform a method, comprising:
receiving a video file selection from a first user for display on a first user device, wherein the video file is an on-demand video file;
receiving a first input from the first user on the first user device via a first graphical user interface at a first time of the video file;
determining a time interval of the selected video file, the time interval being based on the first time of the video file associated with the first input from the first user;
identifying one or more second users on one or more second user devices within the time interval of the video file; and
displaying the first input from the first user to the one or more second users within the time interval of the video file on the one or more second user devices via one or more second graphical user interfaces, the first input being displayed over the video file.

14. A computer program product according to claim 13, comprising:
receiving a second input from one of the one or more second users via one of the one or more second graphical user interfaces at a second time of the video file, the second input being a reply to the first input;
in response to determining the second input is not within the time interval, displaying the second input to the first user via the first graphical user interface in a first color, the second input being displayed over the video file; and
in response to determining the second input is within the time interval, displaying the second input to the first user via the first graphical user interface in a second color, the second input being displayed over the video file.

15. A computer program product as in claim 13, wherein the video file has one or more past user comments associated with one or more time intervals of the video

16. A computer program product as in claim 15, wherein the one or more past user comments are displayed in a first color

17. A computer program product as in claim 16, wherein the first user input is displayed in a second color

18. A computer program product as in claim 13, wherein the first graphical user interface and the one or more second graphical user interfaces are bullet screen interfaces.
